(19) United States
(12) Patent Application Publication
(10) Pub. No.: US 2012/0275007 A1
(43) Pub. Date: Nov. 1, 2012

(54) OPTICAL DEVICES FOR MODULATING LIGHT OF PHOTOREFRACTIVE COMPOSITIONS WITH THERMAL CONTROL

(75) Inventors: Tao Gu, San Diego, CA (US); Weiping Lin, Carlsbad, CA (US); Peng Wang, San Diego, CA (US); Donald Flores, San Diego, CA (US); Michiharu Yamamoto, Carlsbad, CA (US)

(73) Assignee: Nitto Denko Corporation, Ibaraki-Osaka (JP)

(21) Appl. No.: 13/124,833

(22) PCT Filed: Sep. 18, 2009
(86) PCT No.: PCT/US2009/057560

§ 371 Date: Jul. 7, 2011

Related U.S. Application Data
(60) Provisional application No. 61/106,835, filed on Oct. 20, 2008.

(51) Int. Cl. G02F 1/19; G02B 1/12

(52) U.S. Cl. 359/244; 264/1.37

(57) ABSTRACT

Described herein are optical devices comprising a photorefractive layer and at least two inert layers, such that the photorefractive layer is sandwiched between the two inert layers. The photorefractive layer may include a photorefractive composition that is photorefractive upon irradiation by a laser beam. In some embodiments, the photorefractive composition is formulated such that a grating that is irradiated into the photorefractive composition can be read out of the photorefractive composition without applying an external bias voltage. Furthermore, a grating that is written into the composition may be controlled using thermal treatment.

### CROSS-REFERENCE TO RELATED APPLICATIONS

This application claims priority to U.S. Provisional Application Ser. No. 61/106,835 filed on Oct. 20, 2008, entitled “OPTICAL DEVICES FOR MODULATING LIGHT OF PHOTOREFRACTIVE COMPOSITIONS WITH THERMAL CONTROL,” the contents of which are hereby incorporated by reference in their entirety.

### BACKGROUND OF THE INVENTION

1. Field of the Invention

The invention relates to an optical device comprising a photorefractive layer that includes a photorefractive composition and at least two inert layers. The photorefractive composition comprises a sensitizer and a polymer that includes a first repeating unit comprising a moiety selected from the group consisting of a carbazole moiety, a tetraphenyl diaminobiphenyl moiety, and a triphenylamine moiety. Embodiments of the composition can be used in optical applications, including holographic data storage and/or image recording materials.

2. Description of the Related Art

Photorefractivity is a phenomenon in which the refractive index of a material can be altered by changing the electric field within the material, such as by laser beam irradiation. The change of the refractive index typically involves: (1) charge generation by laser irradiation, (2) charge transport, resulting in the separation of positive and negative charges, (3) trapping of one type of charge (charge delocalization), (4) formation of a non-uniform internal electric field (space-charge field) as a result of charge delocalization, and (5) a refractive index change induced by the non-uniform electric field. Good photorefractive properties are typically observed in materials that combine good charge generation, charge transport or photoconductivity and electro-optical activity. Photorefractive materials have many promising applications, such as high-density optical data storage, dynamic holography, optical image processing, phase conjugated mirrors, optical computing, parallel optical logic, and pattern recognition. Particularly, long lasting grating behavior can contribute significantly for high-density optical data storage or holographic display applications.

Originally, the photorefractive effect was found in a variety of inorganic electro-optical crystals, such as LiNbO₃. In these materials, the mechanism of a refractive index modulation by the internal space-charge field is based on a linear electro-optical effect.

In 1990 and 1991, the first organic photorefractive crystal and polymeric photorefractive materials were discovered and reported. Such materials are disclosed, for example, in U.S. Pat. No. 5,064,264, the contents of which are hereby incorporated by reference in their entirety. Organic photorefractive materials offer many advantages over the original inorganic photorefractive crystals, such as large optical nonlinearities, low dielectric constants, low cost, lightweight, structural flexibility, and ease of device fabrication. Other important characteristics that may be desirable depending on the application include sufficiently long shelf life, optical quality, and thermal stability. These kinds of active organic polymers are emerging as key materials for advanced information and telecommunication technology.

In recent years, efforts have been made to improve the properties of organic, and particularly polymeric, photorefractive materials. Various studies have been done to examine the selection and combination of the components that give rise to each of these features. Photoconductive capability can be provided by incorporating materials containing carbazole groups. Phenyl amine groups can also be used for the charge transport portion of the material.

The photorefractive composition may be made by mixing molecular components that provide desirable individual properties into a host polymer matrix. However, previously prepared compositions generally must be written and read out with a large external electric field. For a variety of holographic applications, such as data storage, using a large amount of voltage to read data creates the risk of losing data or otherwise causing disorder to the data. Efforts have been made, therefore, to provide compositions which are photorefractive without applying external bias voltage.

U.S. Patent App. Pub. No. 2008/0039603 and U.S. Pat. No. 6,653,421, the contents of which are both hereby incorporated by reference in their entirety, disclose (meth)acrylate-based polymers and copolymer based materials which are sensitive to green laser and red laser respectively. JP-2006-171320-A and JP-2004-258604 both disclose methods of making PVK and carbazole type photorefractive compositions.

Also, several photorefractive polymers was previously demonstrated in Peng et al., “Synthesis and Characterization of Photorefractive Polymers Containing Transition Metal Complexes as Photosensitizer,” J. Amer. Chem. Soc., 119(20), 4622 (1997) and Darracq et al., “Stable photorefractive memory effect in sol-gel materials,” Appl. Phys. Lett., 70, 292 (1997). A material with long grating holding possesses the ability to exhibit grating signal behavior for hours, even days, after irradiation. Optical devices with these properties are useful for various applications, such as data or image storage. Thus, there remains further need for optical devices comprising materials that provide good photorefractivity performances without needing application of large external bias voltage.

### SUMMARY OF THE INVENTION

An embodiment of the present invention provides an optical device, wherein grating signals can be written and read without the use of a large external bias voltage. The grating can be held for long periods of times, ranging from hours to days, for holographic applications. Also, the grating signal can be controlled by thermal treatment. Embodiments of the organic based materials and holographic medium described herein show good diffraction efficiencies in response to lasers having a wavelength in the range of about 500 nm to about 700 nm. The availability of such materials that are sensitive to a continuous wave laser system can be greatly advantageous and useful for industrial applications, including sensor and optical filter applications.

An embodiment provides an optical device. For example, in an embodiment, the optical device comprises at least two inert layers and a photorefractive layer. In an embodiment, the photorefractive layer is sandwiched between the two inert layers. In an embodiment, the photorefractive layer comprises a photorefractive composition. The photorefractive composition can be photorefractive upon irradiation by a visible light laser beam. In an embodiment, the photorefractive composition comprises a sensitizer and a polymer. In an embodiment, the polymer is a hole-transfer type polymer and comprises a first repeating unit that includes a moiety selected from the group consisting of a carbazole moiety, a tetraphenyl diaminobiphenyl moiety, and a triphenylamine moiety.

For example, the polymer can comprise a first repeating unit that includes at least one moiety selected from the group consisting of the following formulae (Ia), (Ib) and (Ic):

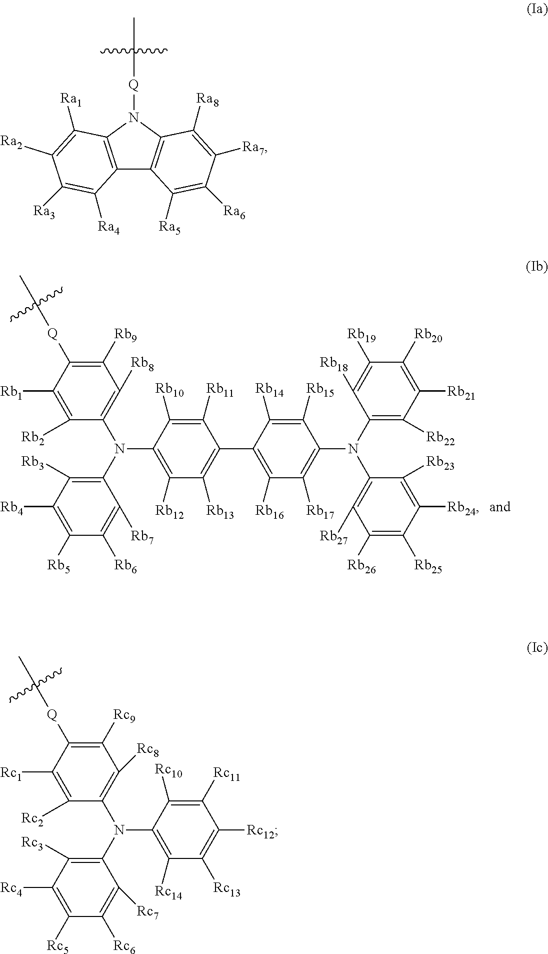

wherein each Q in formulae (Ia), (Ib) and (Ic) independently represents an alkylene or a heteroalkylene; Ra₁-Ra₈, Rb₁-Rb₂₇, and Rc₁-Rc₁₄ in formulae (Ia), (Ib), and (Ic) are each independently selected from the group consisting of hydrogen, linear or branched optionally substituted C₁-C₁₀ alkyl or heteroalkyl, and optionally substituted C₆-C₁₀ aryl.

Unlike conventional photorefractive compositions, which respond to laser irradiation upon the application of large external bias voltage, gratings can be written and read out of the preferred compositions described herein using little or no external bias voltage. Furthermore, the grating behavior of preferred compositions can be controlled using thermal treatment. Controlling the grating behavior can comprise enhancing or increasing the strength of the grating signal. Controlling the grating signal can also comprise turning the grating signal on and off. Preferred photorefractive compositions also exhibit good phase stability.

Also described herein is a method of forming a grating in a photorefractive composition. In an embodiment, the method comprises providing an optical device described herein, and irradiating a photorefractive composition in the optical device with a laser beam. In an embodiment, the laser beam is a green laser. In an embodiment, the laser beam is a red laser. In an embodiment, the grating can be written into the photorefractive composition without applying an external bias voltage. In an embodiment, the grating signal can be read out without applying an external bias voltage.

### BRIEF DESCRIPTION OF THE DRAWINGS

FIG. 1 shows a top-view and cross-section of an embodiment of an optical device.

### DETAILED DESCRIPTION OF THE PREFERRED EMBODIMENT

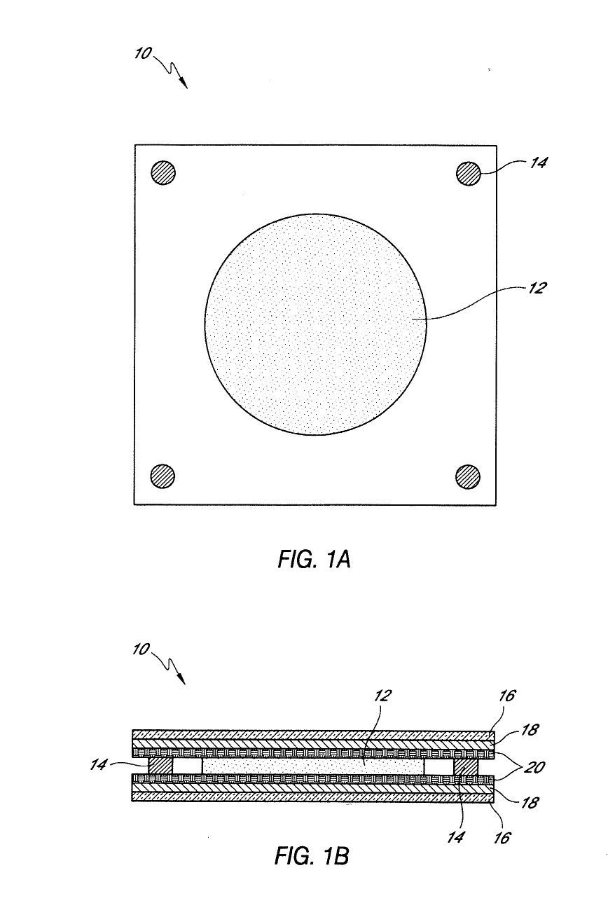

An embodiment provides an optical device comprising at least two inert layers and a photorefractive layer comprising a photorefractive composition, wherein the photorefractive layer is sandwiched between the two inert layers. Additional layers can also be present in the optical device. FIGS. 1A and 1B illustrate a top-view and a cross-section, respectively of an optical device 10 described herein. The figures are not drawn to scale. As can be seen in FIG. 1B, a photorefractive layer 12 comprising a polymer and a sensitizer is sandwiched between two inert layers 20 held apart by spacers 14. In this embodiment, the amount of space occupied by the photorefractive layer 12 and the spacers 14 is generally illustrated by FIG. 1A. The device 10 can further comprise a glass substrate 16 that is coated with indium tin oxide (ITO) 18. Preferably, the ITO 18 portion of the glass substrate is adjacent the inert layers 20.

The photorefractive compositions described herein comprise a sensitizer and a polymer, formulated such that the compositions exhibit photorefractive behavior upon irradiation by a laser beam. In some embodiments, the composition can be made photorefractive upon irradiation by a continuous wave laser. In an embodiment, the polymer comprises a repeating unit that include at least one moiety selected from the group consisting of the carbazole moiety (represented by formula (Ia)), tetraphenyl diaminobiphenyl moiety (represented by the formula (Ib)), and triphenylamine moiety (represented by the formula (Ic)), as described above.

Each of the alkyl, heteroalkyl, or aryl groups in formulae (Ia), (Ib), and (Ic) can be “optionally substituted” with one or more substituent group(s). When substituted, the substituent group(s) is(are) one or more group(s) individually and independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, ester, mercapto, alkylthio, arylthio, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfonyl, sulfonyl, haloalkyl, haloalkoxy, trihalomethanesulfonyl, trihalomethanesulfonamido, and amino, including mono- and di-substituted amino groups, and the protected derivatives thereof. Some non-limiting examples of the substituent group(s) include methyl, ethyl, propyl, butyl, pentyl, isopropyl, methoxide, ethoxide, propoxide, isopropoxide, butoxide, pentoxide and phenyl.

The alkylene or heteroalkylene groups represented by Q in the various formulae described herein, including formulae (Ia), (Ib) and (Ic), can comprise from 1 to about 20 carbon atoms. In an embodiment, Q in formulae (Ia), (Ib) and (Ic) is selected from the group consisting of ethylene, propylene, butylene, pentylene, hexylene, and heptylene, each of which may optionally contain a heteroatom, such as O, N, or S. The heteroalkylene group can comprise one or more heteroatoms. Any heteroatom or combination of heteroatoms can be used, including O, N, S, and any combination thereof.

In some embodiments, the polymer comprising a first repeating unit that includes at least one of formulae (Ia), (Ib), and (Ic) may be polymerized or copolymerized to form a charge transport component of a photorefractive composition. In some embodiments, for example, a polymer comprising a first repeating unit that includes only one of the moieties alone may be polymerized to form a photorefractive polymer. In some embodiments, for example, two or more of the moieties may also be present in a copolymer to form a photorefractive polymer. The polymer or copolymer that includes one, two, or even three of these moieties preferably possesses charge transport ability.

Each of the moieties of formulae (Ia), (Ib), and (Ic) can be attached to a polymer backbone. Many polymer backbones, including but not limited to, polyurethane, epoxy polymers, polystyrene, polyether, polyester, polyamide, polyimide, polysiloxane, and polyacrylate, with the appropriate side chains attached, can be used to make the polymers of the photorefractive composition. Some embodiments contain backbone units based on acrylates or styrene, and some of preferred backbone units are formed from acrylate-based monomers, and some are formed from methacrylate monomers. It is believed that the first polymeric materials to include photoconductive functionality in the polymer itself were the polyvinyl carbazole materials developed at the University of Arizona. However, these polyvinyl carbazole polymers tend to become viscous and sticky when subjected to the heat-processing methods typically used to form the polymer into films or other shapes for use in photorefractive devices.

The (meth)acrylate-based and acrylate-based polymers used in embodiments described herein have good thermal and mechanical properties. Such polymers are durable during processing by injection-molding or extrusion, especially when the polymers are prepared by radical polymerization. Some embodiments provide a composition comprising a sensitizer and a photorefractive polymer that is activated upon irradiation by a laser beam, wherein the photorefractive polymer comprises a repeating unit selected from the group consisting of the following formulae:

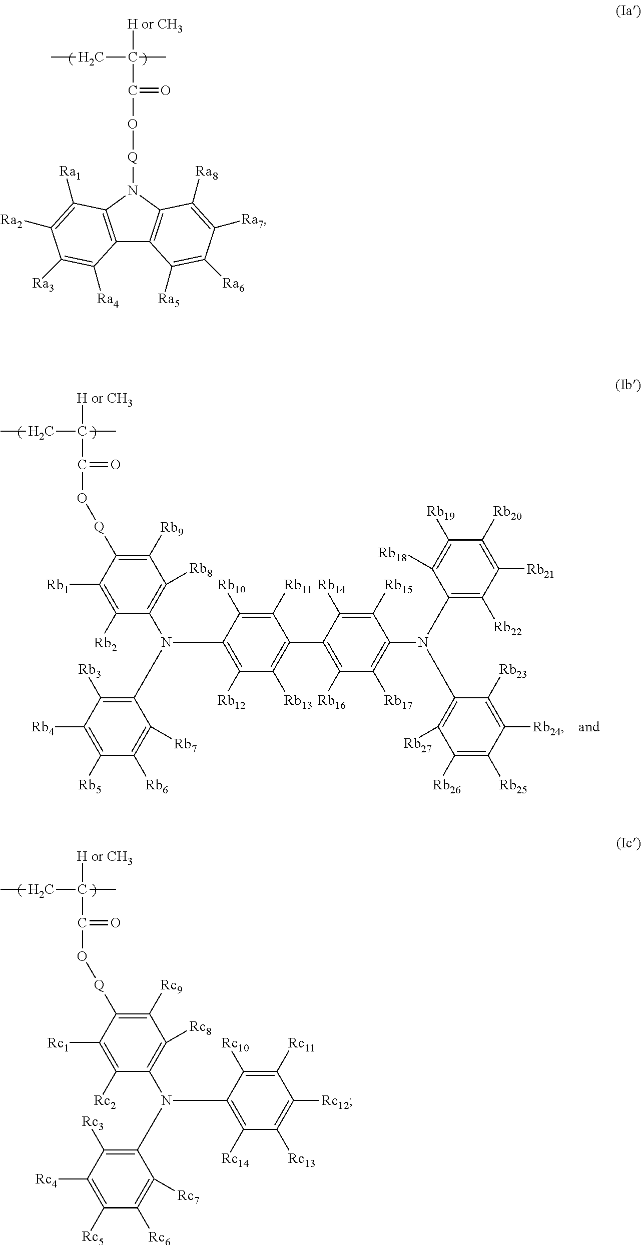

In an embodiment, each Q in formulae (Ia′), (Ib′) and (Ic′) independently represents an alkylene group or a heteroalkylene group. In an embodiment, Ra₁-Ra₈, Rb₁-Rb₂₇ and Rc₁-Rc₁₄ in formulae (Ia′), (Ib′) and (Ic′) are each independently selected from the group consisting of hydrogen, linear or branched optionally substituted C₁-C₁₀ alkyl or heteroalkyl, and optionally substituted C₆-C₁₀ aryl. The hetero atom in the heteroalkylene group or the heteroalkyl group can have one or more heteroatoms selected from S, N, or O.

In some embodiments, a polymer comprising at least one repeating unit that includes a moiety of at least one of formulae (Ia′), (Ib′) and (Ic′) can also be polymerized or copolymerized to form a photorefractive polymer that provides charge transport ability. In some embodiments, monomers comprising a phenyl amine derivative can be copolymerized to form the charge transport component as well. Non-limiting examples of such monomers are carbazolylpropyl(meth)acrylate monomer; 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. These monomers can be used to form polymer by themselves or to form copolymers, e.g., by polymerization of a mixture of two or more monomers.

In preferred embodiments the photorefractive compositions described herein can be photorefractive upon irradiation of a laser beam by incorporation of a sensitizer. Any ingredient which is sensitive to a laser beam upon incorporation into the polymer matrix can be used as the sensitizer. The sensitizer can be added into the composition as a mixture with the polymer and/or be directly bonded to the polymer, e.g., by covalent or other bonding. In an embodiment, the sensitizer comprises a molecule having a structure according to formulae (V), (VI), or (VII):

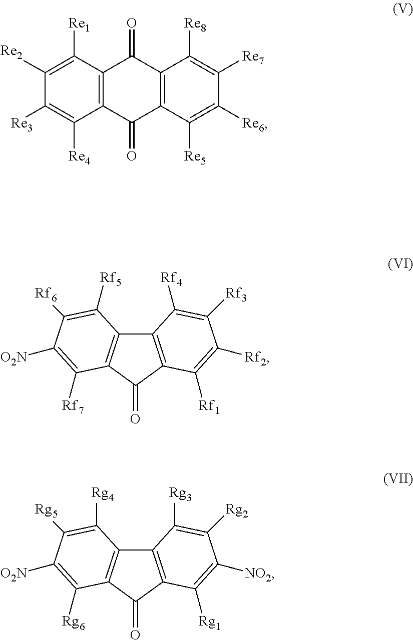

wherein Re₁-Re₈, Rf₁-Rf₇, Rg₁-Rg₆ are each independently selected from the group consisting of hydrogen, linear or branched C₁-C₁₀ alkyl or heteroalkyl, C₆-C₁₀ aryl, and a halogen. If directly attached to the polymer, e.g., by covalent bonding, such bonding can take place at any of Re₁-Re₈, Rf₁-Rf₇, and Rg₁-Rg₆. For example, the sensitizer can be attached to monomers to be copolymerized.

Alternatively, or in addition to attaching the sensitizer to the polymer, sensitizer can also be added to the composition as a separate ingredient. In an embodiment, the sensitizer comprises at least one compound selected from the group consisting of anthraquinone, 2-nitro-9-fluorenone and 2,7-dinitro-9-fluorenone, and combinations thereof.

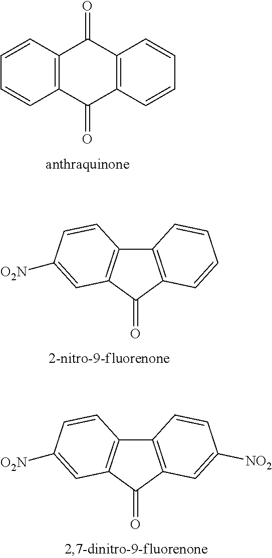

In an embodiment, the photorefractive composition can further comprise a sensitizer other than anthraquinone, 2-nitro-9-fluorenone and 2,7-dinitro-9-fluorenone. However, the inclusion of additional sensitizers should allow for the photorefractive composition to be irradiated upon exposure to a laser beam. Other sensitizers include fullerene and derivatives thereof “Fullerenes” are carbon molecules in the form of a hollow sphere, ellipsoid, tube, or plane, and derivatives thereof. One example of a spherical fullerene is C₆₀. While fullerenes are typically comprised entirely of carbon molecules, fullerenes may also be fullerene derivatives that contain other atoms, e.g., one or more substituents attached to the fullerene. In an embodiment, the sensitizer is a fullerene selected from C₆₀, C₇₀, C₈₄, each of which may optionally be substituted. In an embodiment, the fullerene is selected from soluble C₆₀ derivative [6,6]-phenyl-C61-butyricacid-methylester, soluble C₇₀ derivative [6,6]-phenyl-C₇₁-butyricacid-methylester, or soluble C₈₄ derivative [6,6]-phenyl-C₈₅-butyricacid-methylester. Fullerenes can also be in the form of carbon nanotubes, either single-wall or multi-wall. The single-wall or multi-wall carbon nanotubes can be optionally substituted with one or more substituents.

The amount of sensitizer in the photorefractive composition can vary. In an embodiment, sensitizer is provided in the composition in an amount in the range of about 0.01% to about 30% based on the weight of the composition. In an embodiment, sensitizer is provided in the composition in an amount in the range of about 0.01% to about 20% based on the weight of the composition. In an embodiment, sensitizer is provided in the composition in an amount in the range of about 0.1% to about 10% based on the weight of the composition. In an embodiment, sensitizer is provided in the composition in an amount in the range of about 1% to about 5% based on the weight of the composition.

In some embodiments, the photorefractive composition further comprises another component that has non-linear optical functionality. Like the sensitizer, moieties or chromophores with non-linear optical functionality may be incorporated into the polymer matrix as an additive to the composition or as functional groups attached to monomers to be copolymerized. Moieties or chromophores can be any group known in the art to provide non-linear optical capability.

In an embodiment, other non-linear optical moieties can be incorporated into the composition. In some embodiments, the photorefractive composition comprises additional repeating units having one or more non-linear optical moiety. In some embodiments, the non-linear optical moiety may be presented as a group attached to a monomer that allows copolymerization to form polymers with charge transport moieties. In some embodiments, the photorefractive polymer further comprises a second repeating unit represented by the following formula:

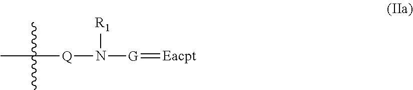

wherein Q in formula (IIa) represents an alkylene group or a heteroalkylene group, the heteroalkylene group has one or more heteroatoms selected from S, N, or O; R₁ in formula (IIa) is selected from the group consisting of hydrogen, linear or branched C₁-C₁₀ alkyl, and C₆-C₁₀ aryl; G in formula (IIa) is a π-conjugated group; and Eacpt in formula (IIa) is an electron acceptor group. In some embodiments, R₁ in formula (IIa) is an alkyl group selected from methyl, ethyl, propyl, butyl, pentyl, and hexyl. In some embodiments, Q in formula (IIa) is an alkylene group represented by (CH₂)ₚ where p is in the range of about 2 to about 10. In some embodiments, Q in formula (IIa) is selected from the group consisting of ethylene, propylene, butylene, pentylene, hexylene, and heptylene.

In some embodiments, the photorefractive polymer comprises a second repeating unit represented by the following formula:

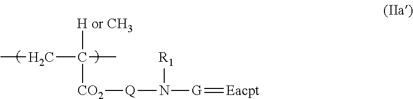

wherein Q in formula (IIa′) represents an alkylene group or a heteroalkylene group, the heteroalkylene group has one or more heteroatom such as S or O; R₁ in formula (IIa′) is selected from the group consisting of hydrogen, linear or branched C₁-C₁₀ alkyl, and C₆-C₁₀ aryl; G in formula (IIa′) is a π-conjugated group and Eacpt in formula (IIa′) is an electron acceptor group. In some embodiments, R₁ in formula (IIa′) is an alkyl group selected from methyl, ethyl, propyl, butyl, pentyl and hexyl. In some embodiments, Q in formula (IIa′) is an alkylene group represented by (CH₂)ₚ where p is in the range of about 2 to about 10. In some embodiments, Q in formula (IIa′) is selected from the group consisting of ethylene, propylene, butylene, pentylene, hexylene, and heptylene.

The term “π-conjugated group” refers to a molecular fragment that contains π-conjugated bonds. The π-conjugated bonds refer to covalent bonds between atoms that have a bonds and it bonds formed between two atoms by overlapping of atomic orbits (s+p hybrid atomic orbits for a bonds and p atomic orbits for it bonds). In some embodiments, G in formulae (IIa) and (IIa′) is independently represented by a formula selected from the following:

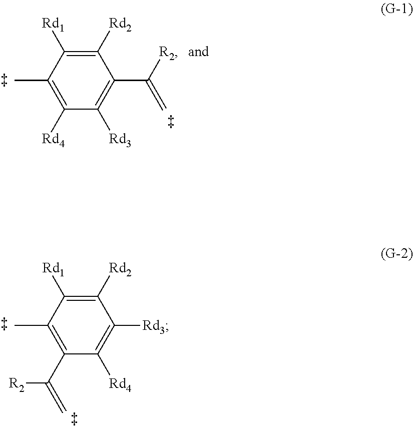

wherein Rd₁-Rd₄ in formulae (G-1) and (G-2) are each independently selected from the group consisting of hydrogen, linear or branched C₁-C₁₀ alkyl, C₆-C₁₀ aryl, and halogen, and R₂ in formulae (G-1) and (G-2) is independently selected from the group consisting of hydrogen, linear or branched C₁-C₁₀ alkyl, and C₆-C₁₀ aryl.

The term “electron acceptor group” refers to a group of atoms with a high electron affinity that can be bonded to a π-conjugated group. Exemplary acceptors, in order of increasing strength, are: C(O)NR²<C(O)NHR<C(O)NH₂<C(O)OR<C(O)OH<C(O)R<C(O)H<CN<S(O)₂R<NO₂, wherein each R in these electron acceptors may independently be, for example, hydrogen, linear or branched C₁-C₁₀ alkyl, or C₆-C₁₀ aryl. As shown in U.S. Pat. No. 6,267,913, examples of electron acceptor groups include:

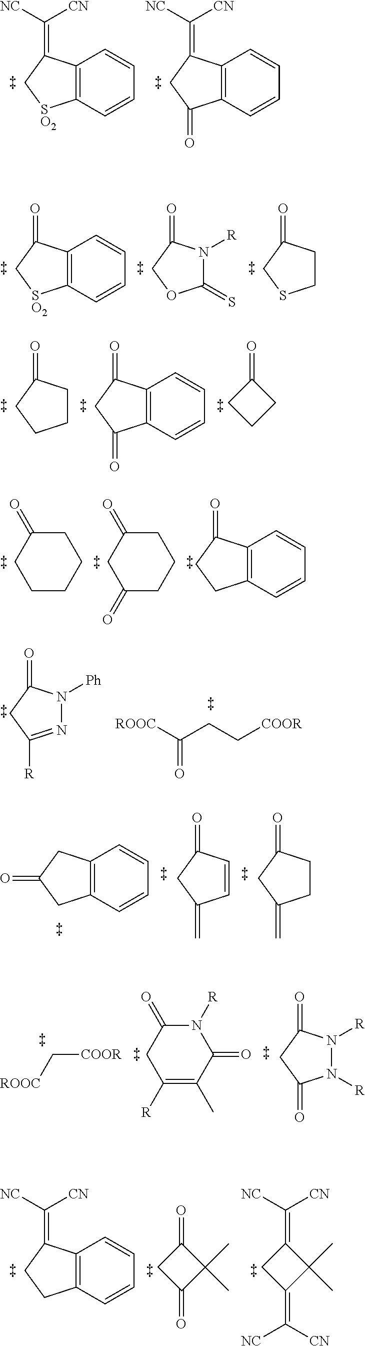

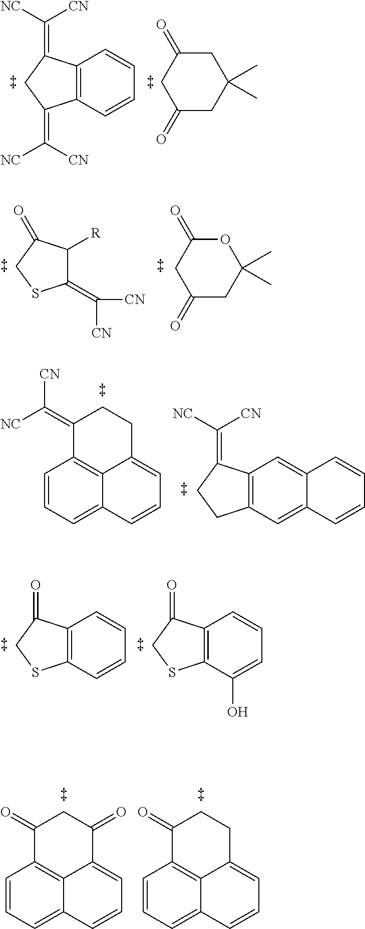

wherein R in each of the above compounds is independently selected from the group consisting of hydrogen, linear or branched C₁-C₁₀ alkyl, and C₆-C₁₀ aryl. The symbol “‡” in a chemical structure specifies an atom of attachment to another chemical group and indicates that the structure is missing a hydrogen that would normally be implied by the structure in the absence of the “‡”.

In some embodiments, Eacpt in formulae (IIa) and (IIa′) may be independently oxygen or a moiety represented by a formula selected from the group consisting of the following:

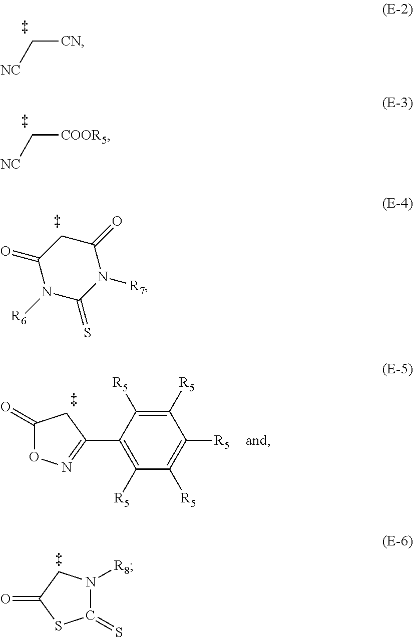

wherein R₅, R₆, R₇ and R₈ in the above formulae are each independently selected from the group consisting of hydrogen, linear or branched C₁-C₁₀ alkyl, and C₆-C₁₀ aryl.

To prepare the non-linear optical component-containing copolymer, monomers that have side-chain groups possessing non-linear-optical ability may be used. Non-limiting examples of such monomers include:

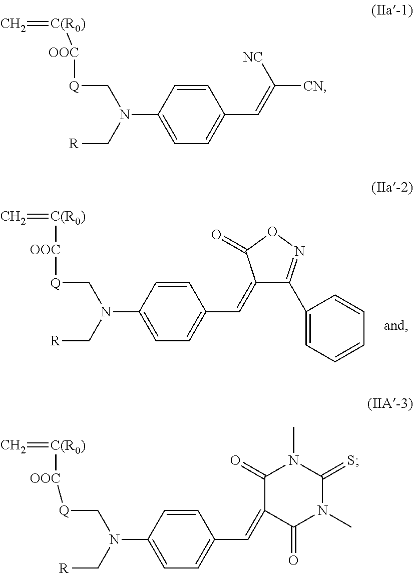

wherein each Q in the monomers above independently represent an alkylene group or a heteroalkylene group, the heteroalkylene group has one or more heteroatoms such as O, N, or S; each R₀ in the monomers above is independently selected from hydrogen or methyl; and each R in the monomers above is independently selected from linear or branched C₁-C₁₀ alkyl. In some embodiments, Q in the monomers above may be an alkylene group represented by (CH₂)ₚ where p is in the range of about 2 to about 6. In some embodiments, each R in the monomers above may be independently selected from the group consisting of methyl, ethyl and propyl.

In some embodiments, monomers comprising a chromophore, can also be used to prepare the non-linear optical component-containing polymer. Non-limiting examples of monomers including a chromophore group as the non-linear optical component include N-ethyl, N-4-dicyanomethylidenyl acrylate and N-ethyl, N-4-dicyanomethylidenyl-3,4,5,6,10-pentahydronaphtylpentyl acrylate.

The amount of chromophore in the photorefractive composition can vary. In an embodiment, chromophore is provided in the composition in an amount in the range of about 0.1% to about 70% based on the weight of the composition. In an embodiment, chromophore is provided in the composition in an amount in the range of about 5% to about 60% based on the weight of the composition. In an embodiment, chromophore is provided in the composition in an amount in the range of about 10% to about 50% based on the weight of the composition. In an embodiment, chromophore is provided in the composition in an amount in the range of about 20% to about 40% based on the weight of the composition.

The polymers described herein may be prepared in various ways, e.g., by polymerization of the corresponding monomers or precursors thereof. Polymerization may be carried out by methods known to a skilled artisan, as informed by the guidance provided herein. In some embodiments, radical polymerization using an azo-type initiator, such as AIBN (azoisobutyl nitrile), may be carried out. The radical polymerization technique makes it possible to prepare random or block copolymers comprising charge transport, sensitizer, and non-linear optical groups. Further, by following the techniques described herein, it is possible to prepare such materials with exceptionally good properties, such as photoconductivity and diffraction efficiency. In an embodiment of a radical polymerization method, the polymerization catalyst is generally used in an amount of from 0.01 mole % to 5 mole % or from 0.1 mole % to 1 mole % per mole of the total polymerizable monomers.

In some embodiments, radical polymerization can be carried out under inert gas (e.g., nitrogen, argon, or helium) and/or in the presence of a solvent (e.g., ethyl acetate, tetrahydrofuran, butyl acetate, toluene or xylene). Polymerization may be carried out under a pressure in the range of about 1 Kgf/cm² to about 50 Kgf/cm² or about 1 Kgf/cm² to about 5 Kgf/cm². In some embodiments, the concentration of total polymerizable monomer in a solvent may be about 0.99% to about 50% by weight, preferably about 2% to about 9.1% by weight. The polymerization may be carried out at a temperature in the range of about 50° C. to about 100° C., and may be allowed to continue for about 1 to about 100 hours, depending on the desired final molecular weight, polymerization temperature, and taking into account the polymerization rate.

Some embodiments provide a polymerization method involving the use of a precursor monomer with a functional group for non-linear optical ability for preparing the copolymers. The precursor may be represented by the following formula:

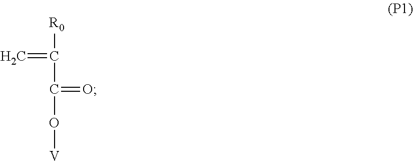

wherein R₀ in (P1) is hydrogen or methyl, and V in (P1) is a group selected from the formulae (V-1) and (V-2):

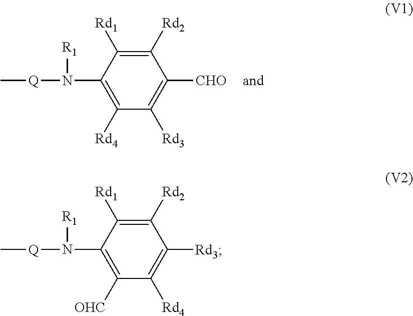

wherein each Q in (V1) and (V2) independently represents an alkylene group or a heteroalkylene group, the heteroalkylene group has one or more heteroatoms such as O and S; Rd₁-Rd₄ in (V1) and (V2) are each independently selected from the group consisting of hydrogen, linear or branched C₁-C₁₀ alkyl, and C₆-C₁₀ aryl, and R₁ in (V1) and (V2) is C₁-C₁₀ alkyl (branched or linear). In some embodiments, Q in (V1) and (V2) may independently be an alkylene group represented by (CH₂)ₚ where p is in the range of about 2 to about 6. In some embodiments, R₁ in (V1) and (V2) is independently selected from the group consisting of methyl, ethyl, propyl, butyl, pentyl and hexyl. In an embodiment, Rd₁-Rd₄ in (V1) and (V2) are hydrogen.

In some embodiments, the polymerization method for the precursor monomer can be carried out under conditions generally similar to those described above. After the precursor copolymer has been formed, it can be converted into the corresponding copolymer having non-linear optical groups and capabilities by a condensation reaction. In some embodiments, the condensation reagent may be selected from the group consisting of:

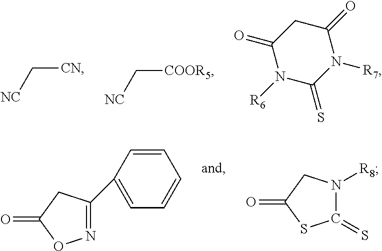

wherein R₅, R₆, R₇ and R₈ of the condensation reagents above are each independently selected from the group consisting of hydrogen, C₁-C₁₀ alkyl and C₆-C₁₀ aryl. The alkyl group may be either branched or linear.

In some embodiments, the condensation reaction between the precursor polymer and the condensation reagent can be carried out in the presence of a pyridine derivative catalyst at room temperature for about 1 to about 100 hrs. In some embodiments, a solvent, such as butyl acetate, chloroform, dichloromethane, toluene or xylene, can also be used. In some embodiments, the reaction may be carried out without the catalyst at a solvent reflux temperature of 30° C. or above for about 1 to about 100 hours.

Other chromophores that possess non-linear optical properties in a polymer matrix are described in U.S. Pat. No. 5,064,264 (incorporated herein by reference) and may also be used in some embodiments. Additional suitable materials known in the art may also be used, and are well described in the literature, such as D. S. Chemla & J. Zyss, “Nonlinear Optical Properties of Organic Molecules and Crystals” (Academic Press, 1987). U.S. Pat. No. 6,090,332 describes fused ring bridge and ring locked chromophores that can form thermally stable photorefractive compositions, which may be useful as well. The chosen compound(s) is sometimes mixed in the copolymer in a concentration of about 1% to about 50% by weight.

In some embodiments, the photorefractive composition further comprises a plasticizer. Any commercial plasticizer such as phthalate derivatives or low molecular weight hole transfer compounds (e.g., N-alkyl carbazole or triphenylamine derivatives or acetyl carbazole or triphenylamine derivatives) may be incorporated into the polymer matrix. An N-alkyl carbazole or triphenylamine derivative containing electron acceptor group is a suitable plasticizer that can help the photorefractive composition be more stable, as the plasticizer contains both N-alkyl carbazole or triphenylamine moiety and a non-linear optical moiety in one compound.

Other non-limiting examples of the plasticizer include ethyl carbazole; 4-(N,N-diphenylamino)-phenylpropyl acetate; 4-(N,N-diphenylamino)-phenylmethyloxyacetate; N-(acetoxypropylphenyl)-N,N′,N′-triphenyl-(1,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more plasticizers. Also, un-polymerized monomers can be low molecular weight hole transfer compounds, for example 4-(N,N-diphenylamino)-phenylpropyl(meth)acrylate; N-[(meth)acroyloxypropylphenyl]-N,N′, N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

In some embodiments, a plasticizer may be selected from N-alkyl carbazole or triphenylamine derivatives:

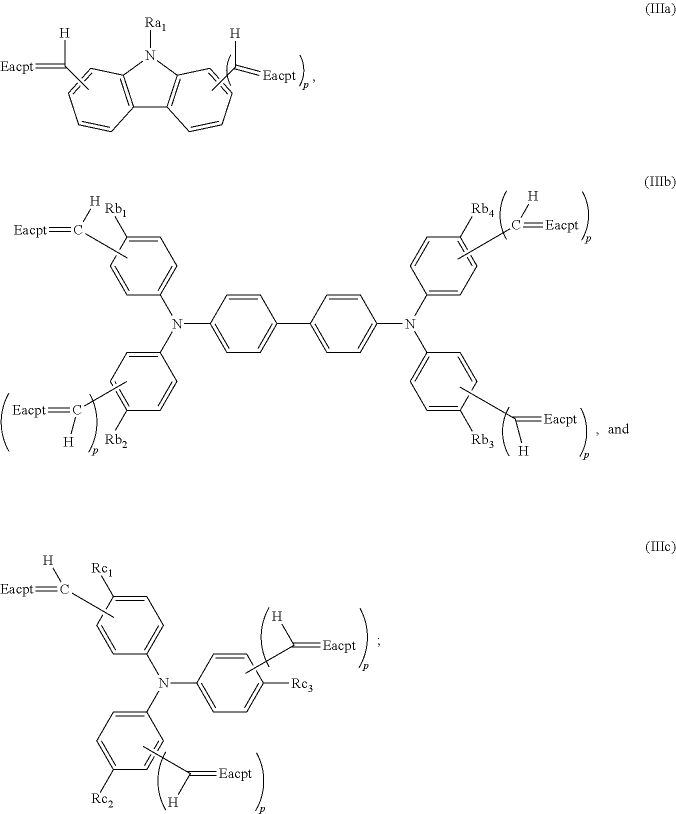

wherein Ra₁, Rb₃-Rb₄ and Rc₁-Rc₃ are each independently selected from the group consisting of hydrogen, branched or linear C₁-C₁₀ alkyl, and C₆-C₁₀ aryl; each p is independently 0 or 1; Eacpt is an electron acceptor group such as an oxygen or a moiety represented by a structure selected from the group consisting of the structures;

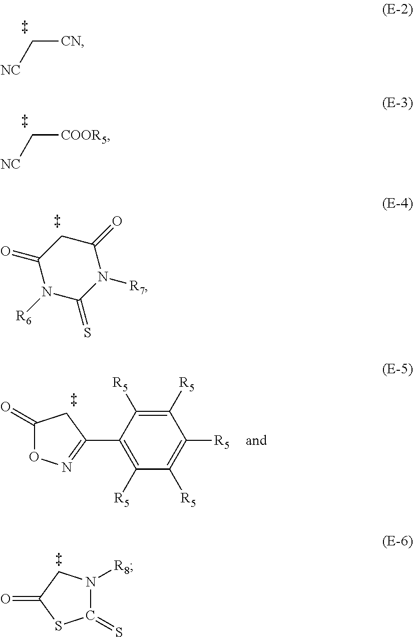

wherein R₅, R₆, R₇ and R₈ in formulae (E-3), (E-4), (E-5), and (E-6) are each independently selected from the group consisting of hydrogen, linear or branched C₁-C₁₀ alkyl, and C₆-C₁₀ aryl.

In some embodiments, the photorefractive composition comprises a copolymer that provides photoconductive (charge transport) ability and non-linear optical ability. The photorefractive composition may also include other components as desired, such as plasticizer components. Some embodiments provide a photorefractive composition that comprises a copolymer. The copolymer may comprise a first repeating unit that includes a first moiety with charge transport ability, a second repeating unit including a second moiety with non-linear optical ability, and a third repeating unit that include a third moiety with plasticizing ability.

The ratio of different types of monomers used in forming the copolymer may be varied over a broad range. Some embodiments provide a photorefractive composition with a first repeating unit having charge transport ability and a second repeating unit having non-linear optical ability, with a weight ratio of the first repeating unit to the second repeating unit in the range of about 100:1 to about 0.5:1, preferably about 10:1 to about 1:1. When the weight ratio of such a first repeating unit to such a second repeating unit is smaller than about 0.5:1, the charge transport ability of copolymer may be too weak to give sufficient photorefractivity. However, even at such a low ratio, sufficient photorefractivity can still be provided by the addition of low molecular weight components having non-linear-optical ability (e.g., as described elsewhere herein). If the weight ratio for such a first repeating unit to such a second repeating unit is larger than about 100:1, the non-linear optical ability of the copolymer by itself may be too low to provide photorefractivity. However, even at such a high ratio, the addition of low molecular weight components having charge transport ability (e.g., as described elsewhere herein) can enhance photorefractivity.

In some embodiments, the molecular weight and the glass transition temperature, Tg, of the copolymer are selected to provide desirable physical properties. In some embodiments, it is valuable and desirable, although not essential, that the polymer is capable of being formed into films, coatings and shaped bodies of various kinds by standard polymer processing techniques (e.g., solvent coating, injection molding or extrusion).

In some embodiments, the polymer has a weight average molecular weight, Mw, in the range of from about 3,000 to about 500,000, preferably in the range from about 5,000 to about 100,000. The term “weight average molecular weight” as used herein means the value determined by the GPC (gel permeation chromatography) method using polystyrene standards, as is well known in the art. In some embodiments, additional benefits may be provided by lowering the dependence on plasticizers. By selecting copolymers with intrinsically moderate Tg and by using methods that tend to depress the average Tg, it is possible to limit the amount of plasticizer in the composition to no more than about 30% or 25%, and in some embodiments, no more than about 20%. In some embodiments, the photorefractive composition that can be activated by a laser beam may have a thickness of about 105 μm and a transmittance of higher than about 30%, more preferably from about 40% to about 90%. If the photorefractive composition has a transmittance of higher than about 30% at a thickness of 105 μm when irradiated by a laser beam, the laser beam can smoothly pass through the composition to form grating image and signals.

An embodiment provides a photorefractive composition that becomes photorefractive upon irradiation by a laser beam, wherein the photorefractive composition comprises a polymer comprising a first repeating unit that includes at least one moiety selected from the group consisting of the formulae (Ia), (Ib) and (Ic) as defined above. In some embodiments, the polymer may further comprise a second repeating unit comprising at least one moiety selected from formula (IIa) and chromophores. In some embodiments, the polymer may further comprise a repeating unit of formula (IIa′). In some embodiments, the polymer may further comprise a third repeating unit that includes at least one moiety selected from formulae (IIIa), (IIIb) and (IIIc). In an embodiment, an optical device comprises any one of the photorefractive compositions described herein.

The optical devices comprising the photorefractive composition can vary. Examples of optical devices that comprises the photorefractive composition include high-density optical data storage devices, dynamic holography devices, optical image processing devices, phase conjugated mirrors, optical computing devices, optical switching devices, parallel optical logic devices and pattern recognition devices. The thermally controllable behavior and characteristic grating enhancement effect of the photorefractive compositions in the devices described herein can significantly enhance sensor and optical filter applications.

Many currently available photorefractive polymers have poor phase stabilities and can become hazy after days. Where the film composition comprising the photorefractive polymer shows significant haziness, poor photorefractive properties are typically exhibited. The haziness of the film composition usually results from incompatibilities between several photorefractive components. For example, photorefractive compositions containing both charge transport ability components and non-linear optical components may exhibit haziness because the components having charge transport ability are usually hydrophobic and non-polar, whereas components having non-linear optical ability are usually hydrophilic and polar. As a result, the natural tendency of the composition is to phase separate, thus causing haziness.

However, preferred embodiments presented herein show good phase stability and gave no haziness, even after several months. Such compositions retain good photorefractive properties, as the compositions are very stable and exhibit little or no phase separation. Without being bound by theory, the stability is likely attributable to the sensitizer and/or a mixture of sensitizer with various chromophores. In addition, the matrix polymer system can be a copolymer of components having charge transport ability and components having non-linear optics ability. That is, the components having charge transport ability and the components having non-linear optical ability can coexist in one polymer chain, therefore rendering significant detrimental phase separation difficult and unlikely.

Furthermore, although heat usually increases the rate of phase separation, preferred compositions described herein exhibit good phase stability, even after being heated. In accelerated heat testing, test samples heated at about 40° C., about 60° C., about 80° C., and about 120° C. are found to be stable after days, weeks, and sometimes even after 6 months. The good phase stability allows the copolymer to be further processed and incorporated into optical device applications for various commercial products.

For preferred photorefractive devices, usually the thickness of a photorefractive layer is in the range of about 10 μm to about 200 μm. Preferably, the thickness range is in the range of about 30 μm to about 150 μm. In many cases, if the sample thickness is less than 10 μm, the diffracted signal is not in the desired Bragg Refraction region, but rather the Raman-Nathan Region, which does not show proper grating behavior. On the other hand, if the sample thickness is greater than 200 μm, composition transmittance for laser beams can often be reduced significantly, resulting in little or no grating signals.

In some embodiments, the composition is configured to transmit about 500 nm to about 700 nm wave length laser beam. In an embodiment, the composition transmits 532 nm wavelength laser light. The photorefractive layer thickness can have an effect on the composition transmittance. Thus, by controlling the thickness of the photorefractive layer comprising a photorefractive composition, the light modulating characteristics can be adjusted as desired. When the transmittance is low, the laser beam may not pass through the layer to form a grating image and signals. On the other hand, if the absorbance is 0%, no laser energy can be absorbed to generate grating signals. In some embodiments, the suitable range of transmittance is about 10% to about 99.99%, about 30% to about 99.9%, or about 35% to about 90%. Linear transmittance was performed to determine the absorption coefficient of the photorefractive device. For measurements, a photorefractive layer was irradiated to an approximately 532 nm laser beam with an incident path perpendicular to the layer surface. The beam intensity before and after passing through the photorefractive layer is monitored and the linear transmittance of the sample is given by:

$$T = \frac{{I}_{Transmitted}}{{I}_{incident}}$$

The wavelength of the laser is not particularly restricted, but is usually in the range of about 500 nm to about 700 nm. Typically, as a laser light source, a widely available 532 nm laser can be used.

One of the various advantages of preferred photorefractive compositions described herein is a long grating holding time. Longer grating holding allows the photorefractive composition to be used for applications such as holographic data storage and image recording. In an embodiment, the grating holding time is one hour or more. In an embodiment, the grating holding time is four hours or more. In an embodiment, the grating holding time is one day or more. In an embodiment, the grating holding time is two days or more. In an embodiment, the grating holding time is one week or more. In an embodiment, the grating holding time is one month or more. In an embodiment, the grating holding time is six months or more. In an embodiment, the grating holding time is one year or more. In an embodiment, the grating holding time is nearly permanent, e.g., ten years or longer.

Furthermore, in preferred embodiments, the long holding grating signal can be written without using an external electric field (expressed as bias voltage), although a bias voltage can optionally be used. Preferably, the grating signal can also be read out without external bias voltage. The ability to read and/or write signals using little or no external bias voltage can be achieved by appropriate selection of the type and amount of sensitizer used in the photorefractive compositions described herein. In an embodiment, the photorefractive compositions described herein have demonstrated grating holding time from minutes to hours at a zero bias voltage.

In preferred embodiments, the photorefractive layer containing a photorefractive composition in the optical device is sandwiched between two inert layers. Sandwiching the photorefractive layer between two inert layers is a preferred way for one to thermally control the grating provided in the photorefractive layer, although other methods may be used as well. For example, the grating can be turned on and off and maintained in either the on or off position at different temperatures in the optical device.

In an embodiment, the at least two inert layers each independently comprise at least one polymer selected from the group consisting of poly(methyl methacrylate), polyvinyl alcohol, crosslinkable polyimide, non-crosslinkable polyimide, polycarbonate, amorphous polycarbonate, and polyvinylpyrrolidone. Other materials can also be included in each of the inert layers, so long as the photorefractive layer can still be thermally controlled. Such other materials include, for example, layers derived from sol-gel, poly(4-vinylphenol), and epoxy polymers.

Additional layers can further be provided in the optical device. In an embodiment, the optical device further comprises two layers of indium tin oxide (ITO)-coated glass plates, wherein the photorefractive layer and the two inert layers are sandwiched between the glass plates. Preferably, the ITO portion of the glass substrate is adjacent to an inert layer.

The thickness of each layer can be independently selected. In an embodiment, the thickness of each of the inert layers is in the range of about 0.01 μm to about 100 μm. In an embodiment, the thickness of each of the inert layers is in the range of about 0.05 μm to about 50 μm. In an embodiment, the thickness of each of the inert layers is in the range of about 0.1 μm to about 20 μm. In an embodiment, the thickness of each of the inert layers is in the range of about 0.1 μm to about 10 μm. In an embodiment, the thickness of each of the inert layers is in the range of about 1 μm to about 5 μm. The thickness of the ITO material on the glass layer, when present, can also vary. In an embodiment, the thickness of the ITO on the glass substrate is in the range of about 0.01 μm to about 1 μm. In an embodiment, the thickness of the ITO on the glass substrate is in the range of about 0.05 μm to about 0.5 μm. In an embodiment, the thickness of the ITO on the glass substrate is in the range of about 0.1 μm to about 0.3 μm.

An embodiment provides a method of forming a grating in a photorefractive composition using the optical devices described herein. In an embodiment, the photorefractive composition is formulated such that a grating that is irradiated into the photorefractive composition can be read out while applying little or no external bias voltage. In an embodiment, the method comprises providing an optical device comprising a photorefractive composition and irradiating the photorefractive composition with a laser beam. In an embodiment, a grating is written into the photorefractive composition. In an embodiment, the grating is written into the photorefractive composition without applying an external bias voltage. In an embodiment, a grating signal is read out of the device. In an embodiment, a grating signal is read out of the device without applying an external bias voltage. In an embodiment, the wavelength of the laser is in the range of from about 500 nm to about 700 nm. In an embodiment, the wavelength of the laser is about 532 nm.

The grating signal can be controlled by thermal treatment, e.g., by changing the temperature of the photorefractive composition. For example, the strength of the grating signal can be enhanced by thermal treatment. In an embodiment, a grating signal can be turned “off” by heating the photorefractive composition and turned “on” by allowing the photorefractive composition to cool, e.g., to room temperature. In another embodiment, a grating signal can be turned “on” by heating the photorefractive composition and turned “off” by allowing the photorefractive composition to cool, e.g., to room temperature. The manner in which the grating signal is controlled by thermal treatment depends upon whether the grating is written into a photorefractive composition that is pre-heated or a photorefractive composition that is not pre-heated.

In an embodiment, the grating signal is enhanced by heat treatment. Laser beam irradiation of a photorefractive composition in a device at room temperature, e.g. in the range of about 16° C. to about 24° C., for several minutes initially provides a composition having a relatively weak grating signal. For example, the grating signal can be less than about 0.2 μw, or even less than about 0.1 μw. The signal may be so weak that one of ordinary skill in the art would consider it to be “off” and insufficient to provide a useful grating signal. However, thermal treatment can be used to enhance the grating signal. As the photorefractive composition is heated to a higher temperature, the grating signal may remain significantly weak, and can actually become weaker. The grating signal may also remain weak when the photorefractive composition is held at the peak temperature of heating. However, improvement in grating signal may be observed after the heat is removed and the composition returns to room temperature. Thus, in an embodiment, by the time that the composition reaches room temperature, a more intense grating signal develops. The degree of enhanced grating signal can be monitored in real-time using known methods, such as an oscilloscope.

The “higher” temperature selected for heat treatment after irradiation can vary, so long as the grating signal increases in intensity after the heat treatment is removed. In an embodiment, the higher temperature is in the range of about 40° C. to about 80° C. In an embodiment, the higher temperature is in the range of about 50° C. to about 70° C. In an embodiment, the higher temperature is in the range of about 55° C. to about 65° C. In an embodiment, the higher temperature is about 60° C. Preferably, the photorefractive composition is held at the higher temperature over the course of several minutes before being allowed to cool. The duration of the heat treatments can vary. In an embodiment, the heat treatment is in the range of about 1 minute to about 20 minutes. In an embodiment, the heat treatment is in the range of about 2 minutes to about 10 minutes. In an embodiment, the heat treatment is in the range of about 3 minutes to about 5 minutes.

The increased grating signal intensity after the initial heat treatment can be about two times stronger than the grating intensity without heat treatment. In an embodiment, the grating signal intensity is about four times stronger than the grating intensity without heat treatment. In an embodiment, the grating signal intensity is about ten times stronger than the grating intensity without heat treatment. In an embodiment, the grating signal intensity is about twenty times stronger than the grating intensity without heat treatment. While the grating signal of the photorefractive composition at room temperature is much improved after one heat treatment, the signal can be further improved by repeating the heat treatments. After heating the composition and returning it to a higher temperature, the grating signal once again returns to being very weak. In an embodiment, a repeated heat treatment is substantially similar to the initial heat treatment in temperature. In an embodiment, a repeated heat treatment is substantially similar to the initial heat treatment in duration.

The photorefractive composition can then be allowed, once again, to return to room temperature. The grating signal at room temperature typically increases in strength after each heat treatment, up to a point. After several heat treatments, e.g., about two to about ten heat treatments, a maximum grating signal can be achieved. The resulting heat-treated photorefractive composition thus has a strong grating signal when measured at room temperature and a weak grating signal when measured at a higher temperature.

After enhancing the grating signal using heat treatment, the grating signal of the photorefractive composition can be turned “off” and “on” by applying a heat treatment and removing the heat treatment, respectively. A person having ordinary skill in the art in view of the guidance provided herein can turn off the grating signal by heating the optical device to a higher temperature, and then turn on the grating signal by removing the heat from the optical device.

An embodiment provides a method for modulating a grating signal of an optical device. In an embodiment, the method comprises providing an optical device comprising a photorefractive composition and two inert layers, to which a grating has been written therein by irradiating the photorefractive composition with a laser beam at a first temperature. In an embodiment, the grating has been enhanced with an initial thermal treatment. In an embodiment, the method comprises increasing the temperature of the optical device to a second temperature, wherein the intensity of the grating signal at the first temperature is higher than the intensity of the grating signal at the second temperature.

For example, the first temperature at which the grating is written into the photorefractive composition can be about room temperature. In an embodiment, the first temperature is in the range of about 16° C. to about 24° C. In an embodiment, the first temperature is in the range of about 18° C. to about 22° C. In an embodiment, the first temperature is in the range of about 19° C. to about 21° C.

After the grating is initially written into the photorefractive composition, the intensity of the grating signal may be very weak, but can be enhanced as previously discussed. In an embodiment, the grating signal is measured at the first temperature without applying an external bias voltage. In an embodiment, the grating signal is measured at the second temperature without applying an external bias voltage. In an embodiment, the grating signal is measured at the first and second temperatures without applying an external bias voltage.

Heating the optical device to the second temperature may be effective in turning the grating signal off, as described above. In an embodiment, the second temperature is in the range of about 40° C. to about 80° C. In an embodiment, the second temperature is in the range of about 50° C. to about 70° C. In an embodiment, the second temperature is in the range of about 55° C. to about 65° C. In an embodiment, the second temperature is in the range of about 60° C.

The intensity of the grating signal at the first temperature may be higher than the intensity of the grating signal at the second temperature, as described above. In an embodiment, the grating signal at the first temperature is at least about 50% higher compared to the intensity of the grating signal at the second temperature. In an embodiment, the grating signal at the first temperature is at least 60% about higher compared to the intensity of the grating signal at the second temperature. In an embodiment, the grating signal at the first temperature is at least about 70% higher compared to the intensity of the grating signal at the second temperature. In an embodiment, the grating signal at the first temperature is at least about 75% higher compared to the intensity of the grating signal at the second temperature. In an embodiment, the grating signal at the first temperature is at least about 80% higher compared to the intensity of the grating signal at the second temperature. In an embodiment, the grating signal at the first temperature is at least about 90% higher compared to the intensity of the grating signal at the second temperature.

After the optical device is heated to the second temperature and the grating signal is weakened or turned off, the heat can be removed. As the device returns to the first temperature, the grating signal returns to about the original intensity, or higher as described above. In an embodiment, the method further comprises decreasing the temperature of the optical device, such that the intensity of the grating signal is substantially restored or enhanced. In an embodiment, the grating signal is on after decreasing the temperature of the optical device. In an embodiment, the grating signal returns to about the maximum intensity grating signal. In an embodiment, the temperature is decreased such that it returns to a temperature about the same as the first temperature.

Heating the optical device to turn the grating signal off, and then decreasing the temperature back to the first temperature to turn the device on can be repeated many times. In an embodiment, the grating signal is on at the first temperature and the grating signal is off at the second temperature.

It is also possible to erase the grating from the photorefractive composition. Heat treatment of a higher order, e.g., to a temperature greater than about 80 or 90° C., can be used to erase the grating signal. After the grating has been erased from the photorefractive composition, a new grating may then be irradiated therein. Therefore, the optical device can be reusable to irradiate different gratings.

In another embodiment, an inverse effect of turning “on” the grating signal upon heating and turning “off” the grating signal upon cooling can be achieved. Such an inverse embodiment can be achieved by irradiating the grating signal into a composition that is pre-heated, e.g. held at a temperature above room temperature. Before writing the grating with a laser beam, the photorefractive composition is pre-heated. A “pre-heated” temperature is a temperature that is above room temperature. For example, the pre-heated temperature can be about 25° C. or higher. In an embodiment, the pre-heated temperature is about 30° C. or higher. In an embodiment, the pre-heated temperature is about 35° C. or higher. In an embodiment, the pre-heated temperature is about 40° C. or higher. In an embodiment, the pre-heated temperature is about 45° C. or higher. In an embodiment, the pre-heated temperature is about 50° C. or higher. Upon laser beam irradiation of the photorefractive composition at the pre-heated temperature, a grating signal is quickly observed during the initial stages of the irradiation. For example, in one embodiment, the grating signal is half as strong as the maximum grating signal after three minutes of irradiation when the composition is held at about 35° C. After several more minutes at the pre-heated temperature, a maximum signal is reached.

After signal writing is completed, the heat is removed from the photorefractive composition and the device cools back down to room temperature from its pre-heated condition. In this embodiment, when the device reaches room temperature, the grating signal is very weak such that one having ordinary skill in the art would consider it “off.” However, the grating signal can be turned back “on” by applying a heat treatment to the optical device. Repeatedly applying a heat treatment can then effectively turn the grating signal “on” in the photorefractive composition and repeatedly removing the heat treatment can then effectively turn the grating signal “off.”

Pre-heating the photorefractive composition before irradiation with a laser beam allows one to control the temperature at which the grating can be turned on and off. In an embodiment, the temperature at which the photorefractive composition is preheated is substantially similar to the temperature at which a maximum grating signal is achieved. Thus, if the grating signal is written at about 35° C., then the maximum grating signal (e.g. when the signal is “on”) will be expected to be reached at about 35° C. In addition, preheating the composition prior to writing the grating lowers the temperature at which the grating may be erased.

An embodiment provides a method for modulating a grating signal of an optical device, comprising providing an optical device comprising a photorefractive composition to which a grating has been written therein by irradiating the photorefractive composition with a laser beam at a first temperature and cooling the optical device to a second temperature, wherein the intensity of the grating signal at the first temperature is higher than the intensity of the grating signal at the second temperature.

The “first temperature” and the “second temperature” in this inverse embodiment are not necessarily the same as the first temperature and second temperature of the embodiment involving grating irradiation at room temperature. Rather, in this embodiment, when irradiation of the photorefractive composition takes place at a pre-heated temperature (first temperature), the second temperature is lower than the first. In an embodiment, the first temperature is in the range of about 25° C. to about 50° C. In an embodiment, the first temperature is in the range of about 30° C. to about 45° C. In an embodiment, the first temperature is in the range of about 33° C. to about 37° C. In an embodiment, the first temperature is about 35° C.

In an embodiment, the second temperature of the photorefractive composition after decreasing the temperature of the optical device is about room temperature. In an embodiment, the second temperature is in the range of about 16° C. to about 24° C. In an embodiment, the second temperature is in the range of about 18° C. to about 22° C. In an embodiment, the second temperature is in the range of about 19° C. to about 21° C.

In such an inverse embodiment, the intensity of the grating signal at the first temperature is higher than the intensity of the grating signal at the second temperature. In an embodiment, the grating signal at the first temperature is at least about 50% higher compared to the intensity of the grating signal at the second temperature. In an embodiment, the grating signal at the first temperature is at least about 60% higher compared to the intensity of the grating signal at the second temperature. In an embodiment, the grating signal at the first temperature is at least about 70% higher compared to the intensity of the grating signal at the second temperature. In an embodiment, the grating signal at the first temperature is at least about 75% higher compared to the intensity of the grating signal at the second temperature. In an embodiment, the grating signal at the first temperature is at least about 80% higher compared to the intensity of the grating signal at the second temperature. In an embodiment, the grating signal at the first temperature is at least about 90% higher compared to the intensity of the grating signal at the second temperature.

The grating signal measurements can be made without applying an external bias voltage. In an embodiment, the grating signal is measured at the first temperature without applying an external bias voltage. In an embodiment, the grating signal is measured at the second temperature without applying an external bias voltage. In an embodiment, the grating signal is measured at the first and second temperatures without applying an external bias voltage.

After the optical device is cooled to the second temperature and the grating signal is weakened or turned off, the heat treatment can be repeated. As the device returns to the first temperature, the grating signal returns to the original maximum intensity at the higher temperature. In an embodiment, the method further comprises increasing the temperature of the optical device, such that the intensity of the grating signal is substantially restored. In an embodiment, the grating signal is on after increasing the temperature of the optical device. In an embodiment, the grating signal returns to the maximum intensity grating signal. In an embodiment, the temperature is increased such that it returns to a temperature about the same as the first temperature.

Decreasing the temperature of the optical device to turn the grating signal off, and then increasing the temperature back to the first temperature to turn the device on can be repeated many times. In an embodiment, the grating signal is on at the first temperature and the grating signal is off at the second temperature.

Similar to the embodiment where applying heat turns the grating signal “off” and removing heat turns the grating signal “on,” it is also possible to erase the grating by applying heat treatment. However, erasing a grating that is written in a pre-heated composition can typically be achieved at a lower temperature than erasing a grating that is written at room temperature. For example, erasing a grating written into a pre-heated composition can be performed at a temperature of about 50° C. or about 55° C., or greater. After the grating has been erased from the photorefractive composition, a new grating may then be irradiated therein. Thus, the optical device is reusable.

Methods of heating (e.g. increasing the temperature of the device) and cooling (e.g. decreasing the temperature of the device) can vary. For example, heating can be done by placing the device in a heat source, e.g., furnace or oven, or by applying a heating device on the optical device. In addition, cooling can take place a number of ways. The device can simply be removed from a heat source and be allowed to remain in an ambient environment to return to room temperature or an affirmative cooling mechanism can be used. Those having ordinary skill in the art, guided by the disclosure herein, will understand the heating and cooling techniques commonly used in these applications.

The thermally controlled behavior of turning the grating signal on and off, along with the ability to enhance the grating signal using thermal heat treatments allows preferred embodiments of the optical devices described herein to be useful for sensor and optical filter applications.

An additional advantage of the preferred photorefractive compositions is the high diffraction efficiency, η, that can be achieved. Diffraction efficiency is defined as the ratio of the intensity of a diffracted beam to the intensity of an incident probe beam, and is determined by measuring the intensities of the respective beams. A ratio of 100% provides the most efficient device. In some embodiments, the diffraction efficiency is at least about 30%. In some embodiments, the diffraction efficiency is at least about 40%. In some embodiments, the diffraction efficiency is at least about 50%.

The embodiments are now further described by the following examples, which are intended to be illustrative of the invention, but are not intended to limit the scope or underlying principles in any way.

### Example 1

### (a) Monomers Containing Charge Transport Groups

TPD acrylate type charge transport monomers (N-[acroyloxypropylphenyl]-N,N′,N′-triphenyl-(1,1′-biphenyl)-4,4′-diamine) (TPD acrylate) were purchased from Fuji Chemical, Japan. The TPD acrylate type monomer possessed the structure:

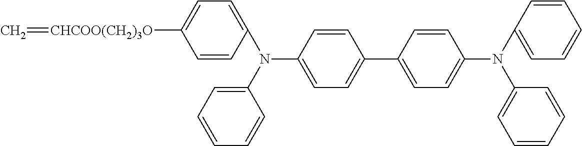

### (b) Monomers Containing Non-Linear Optical Groups

The non-linear-optical precursor monomer 5-[N-ethyl-N-4-formylphenyl]amino-pentyl acrylate was synthesized according to the following synthesis scheme:

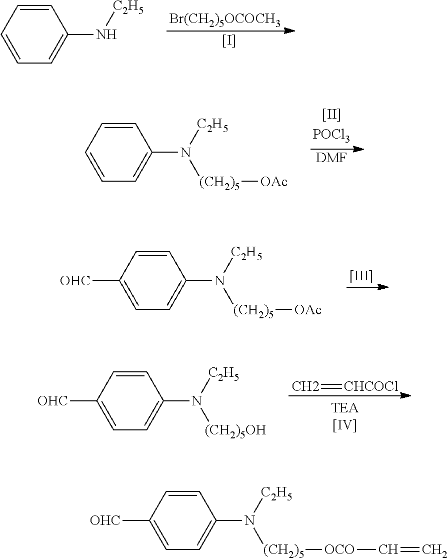

STEP I: Bromopentyl acetate (5 mL, 30 mmol), toluene (25 mL), triethylamine (4.2 mL, 30 mmol), and N-ethylaniline (4 mL, 30 mmol) were added together at room temperature. The mixture was heated at 120° C. overnight. After cooling down, the reaction mixture was rotary-evaporated to form a residue. The residue was purified by silica gel chromatography (developing solvent: hexane/acetone=9/1). An oily amine compound was obtained. (Yield: 6.0 g (80%))

STEP II: Anhydrous DMF (6 mL, 77.5 mmol) was cooled in an ice-bath. Then, POCl₃ (2.3 mL, 24.5 mmol) was added dropwise into the cooled anhydrous DMF, and the mixture was allowed to come to room temperature. The amine compound (5.8 g, 23.3 mmol) was added through a rubber septum by syringe with dichloroethane. After stirring for 30 min., the reaction mixture was heated to 90° C. and the reaction was allowed to proceed overnight under an argon atmosphere. After the overnight reaction, the reaction mixture was cooled and poured into brine water and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate=3/1). An aldehyde compound was obtained. (Yield: 4.2 g (65%))

STEP III: The aldehyde compound (3.92 g, 14.1 mmol) was dissolved in methanol (20 mL). Into the solution, potassium carbonate (400 mg) and water (1 mL) were added at room temperature and the solution was stirred overnight. Next, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=1/1). An aldehyde alcohol compound was obtained. (Yield: 3.2 g (96%))

STEP IV: The aldehyde alcohol (5.8 g, 24.7 mmol) was dissolved in anhydrous THF (60 mL). Into the solution, triethylamine (3.8 mL, 27.1 mmol) was added and the solution was cooled by ice-bath. Acrolyl chloride (2.1 mL, 26.5 mmol) was added and the solution was maintained at 0° C. for 20 minutes. Thereafter, the solution was allowed to warm up to room temperature and stirred at room temperature for 1 hour, at which point TLC indicated that all of the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography (developing solvent: hexane/acetone=1/1). The compound yield was 5.38 g (76%), and the compound purity was 99% (by GC).

### (c) Purification of Non-Linear Optical Chromophore NPP

NPP ((s)-(−)-1-(4-nitrophenyl)-2-pyrrolidinemethanol, 98%.), commercial available from Aldrich, used after recrystallization.

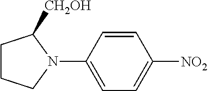

### (d) Plasticizers

N-Ethylhexylcarbazole, commercial available from Aldrich, used as received.

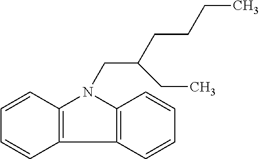

### (e) Sensitizer

Anthraquinone, commercial from Aldrich, used as received.

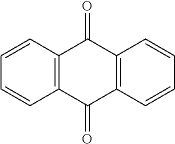

### Example 2

### Preparation of Copolymer by AIBN Radical Initiated Polymerization (TPD Acrylate/Chromophore Type 10:1)

The charge transport monomer N-[(meth)acroyloxypropylphenyl]-N,N′,N′-triphenyl-(1,1′-biphenyl)-4,4′-diamine (TPD acrylate) (43.34 g), and the non-linear optical precursor monomer 5-[N-ethyl-N-4-formylphenyl]amino-pentyl acrylate (4.35 g), prepared as described in Example 1, were put into a three-necked flask. After toluene (400 mL) was added and purged by argon gas for 1 hour, azoisobutylnitrile (118 mg) was added into the solution. Then, the solution was heated to 65° C., while continuing to purge with argon gas.

After 18 hrs of polymerization, the polymer solution was diluted with toluene. The polymer was precipitated from the solution and added to methanol, then the resulting polymer precipitate was collected and washed in diethyl ether and methanol. The white polymer powder was collected and dried. The yield of polymer was 66%.

The weight average and number average molecular weights were measured by gel permeation chromatography, using polystyrene standards. The results were Mn=10,600, Mw=17,100, giving a polydispersity of 1.61.

### Example 3

### Fabrication of Inert Layer Modified ITO Glass

About 2.0 g of polymer (amorphous polycarbonate) powder was dissolved in about 20 ml dichloromethane. The solution was stirred under ambient condition overnight to ensure substantially total dissolution. The solution was then filtered through an approximately 0.2 μm PTFE filter and spin-coated onto ITO glass substrate. The film was then pre-baked at about 80° C. for about a minute, and vacuum baked at about 80° C. overnight. The thickness of the inert layer was adjustable to be between about 0.5 μm and about 50 μm, depending on the initial spin-coating speed and polymer concentration.

### Production of Optical Device

A photorefractive composition testing sample was prepared. The components of the composition were provided in approximate amounts as follows:

| | |
|---|---|
| (i) Matrix polymer (described in Example 2): | 46.93 wt % |
| (ii) NPP chromophore | 25.03 wt % |
| (iii) Ethylhexyl carbazole plasticizer | 25.03 wt % |
| (iv) Anthraquinone sensitizer | 3.01 wt % |

To prepare the composition, the components listed above were dissolved in dichloromethane with stirring and then dripped onto glass plates at 60° C. using a filtered glass syringe. The composites were then cooked at 60° C. for five minutes and then vacuumed for five minutes. The composites were then cooked at 150° C. for five minutes and then vacuumed 30 seconds. The composites were then scrapped and cut into chunks. Small portions of a photorefractive chunk were taken off and sandwiched between two amorphous polycarbonate layers, which were each coated onto ITO-covered glass plates. The inert layers were separated by a 105 μm spacer. The final sample was in the form generally illustrated in FIG. 1. The thickness of each of the inert layers and the each of the ITO coated glass plates were about 10 μm and about 0.15 μm, respectively.

The photorefractive composition in the device was subjected to laser irradiation for ten minutes at 20° C. (e.g., room temperature). A very weak grating signal of about 0.07 μw was read out from an oscilloscope at room temperature. Afterwards, the device was heated to about 60° C. over the course of about a minute. During heating, the grating signal read out at a minimum intensity, similar to the room temperature reading.

After the heating stage was stopped, the read out intensity of the signal grating started increasing and reached up to about 2.0 μw. The heating step was repeated, during which the grating read out dropped again to a minimal intensity. Heating was stopped and the device cooled back to room temperature, then the grating intensity increased up to about 3.8 μw. A heating treatment was repeated a third time. The grating intensity, again, lowered during heating and then, after cooling, increased to about 5.0 μw. After two more heating cycles, the grating intensity reached a maximum about 6.0 μw at room temperature. This maximum signal was achieved after about a half an hour of repeated heat treatments.

Thereafter, upon repeated heating, the grating signal dropped to a significantly low intensity (grating off), and then, upon repeatedly removing the heat, the grating intensity returned to a maximum signal of about 6.0 μw (grating on). Turning the grating off and on by application of heat was repeated many times. The grating was kept “on” for periods of hours and days. The grating was kept “off” under heat for several minutes, e.g., greater than 10 minutes. The grating was also erased upon heating the device to a temperature of 100° C.

### Measurement 1—Diffraction Efficiency

The diffraction efficiency of the photorefractive composition of the optical device was measured at about 532 nm by a four-wave mixing experiments. Steady-state four-wave mixing experiments were performed using two writing beams making an angle of about 20.5 degree in air; with the bisector of the writing beams making an angle of about 60 degrees relative to the sample normal.

For the four-wave mixing experiments, two s-polarized writing beams with equal intensity of about 0.2 W/cm² in the sample were used; the spot diameter was about 600 μm. A p-polarized beam of about 1.7 mW/cm² counter propagating with respect to the writing beam nearest to the surface normal was used to probe the diffraction gratings; the spot diameter of the probe beam in the sample was about 500 μm. The diffracted and the transmitted probe beam intensities were monitored to determine the diffraction efficiency. Evaluation of the photorefractive effect of the device was performed by irradiating coherent light without impression of an electrical potential difference. This diffraction efficiency was calculated from formula 1.

Diffraction efficiency={diffracted light reinforcement/(diffracted light reinforcement+transmitted light reinforcement)}×100% [formula 1]

### Measurement 2—Transmittance

For the transmittance measurements, a photorefractive layer was irradiated to with a 532 nm laser beam with an incident path perpendicular to the layer surface. A p-polarized probe beam nearest to the surface normal in four-wave mixing experiments was used. The beam intensity before and after passing through the photorefractive layer is monitored and the linear transmittance of the sample is given by:

$$T = \frac{{I}_{Transmitted}}{{I}_{incident}}$$

### Measurement 3—Response Time

Response time is the time needed to build up half of the diffraction grating in the photorefractive material upon irradiation to a laser writing beam.

### Comparative Example 1

The first comparative example was made without inert layers. An optical device was obtained in the same manner as in the Example 3 except that the sample device was made without either of the amorphous polycarbonate inert layers.

### Comparative Example 2

A second comparative example was made without a sensitizer. An optical device was obtained in the same manner as in the Example 3 except that the components of the composition were provided in approximate amounts as follows:

| | |
|---|---|
| (i) Matrix polymer (described in Example 2): | 50 wt % |
| (ii) DCST chromophore | 30 wt % |
| (iii) Ethyl carbazole plasticizer | 20 wt % |

### Example 4

An optical device was obtained in the same manner as in the Example 3 except that the sample device was pre-heated to 35° C. prior to writing the grating. Upon laser irradiation, the grating reached a maximum signal after about 10 minutes. The pre-heating was stopped, and the temperature of the device dropped to about room temperature (about 20° C.). At room temperature, the grating signal dropped to a low intensity and stayed at the low intensity (grating off). The photorefractive composition was then heated back up to 35° C. and the grating signal started increasing to a high intensity and maintained the high intensity (grating on) under heat. Turning the grating on and grating off can then be repeated by heating and cooling back to room temperature. Once the composition was heated to temperature higher than 55° C., the grating erased. Thus, the preheating process not only provides a thermal control grating on/off, but also controls which temperature the grating is turned on and off.

### Comparative Example 3

An optical device was obtained in the same manner as in the Example 3 except that the grating signal of the sample device was measured without any thermal treatment to enhance the grating signal. The device was kept and measured at room temperature. After 10 minutes of laser beam irradiation, only a very weak grating signal could be monitored.

Table 1 below provides the data obtained for Examples 3 and 4 and Comparative Examples 1-3. Each of the examples had a similar transmittance. However, Comparative Example 1, which did not have any inert layers, and Comparative Example 2, which did not have any sensitizer, did not provide diffraction efficiency at zero bias voltage. Additionally, the bias voltage of Comparative Example 3 was also low because the grating written in Comparative Example 3 was not subjected to enhancement by thermal treatment. The grating holding times of Example 3 and 4 show that the gratings can exist in the compositions after being turned “on” and “off” for long periods of time.

TABLE 1
Performances of the Photorefractive Compositions in Each Optical Device

| | | | | Grating holding |
|---|---|---|---|---|
| | | Diffraction | Response | to half of |
| | Transmittance | efficiency at | time | maximum |
| Example | (%) | zero bias | (s) | efficiency |
| 3 | 38% | 44% | ~2000 s | >20 days |
| Comparative | 38% | none | — | — |
| Example 1 | | | | |
| Comparative | 35% | none | — | — |
| Example 2 | | | | |
| 4 | 38% | 38% | 160 s | Several hours |
| Comparative | 38% | <1% | — | — |
| Example 3 | | | | |

Table 2 compares the thermal effect on an optical device having its grating written at room temperature (Example 3) and an optical device having its grating written at a pre-heated temperature (Example 4). Both examples provided excellent diffraction efficiency and good response times. An inverse effect for turning the grating on and turning the grating off by heating/cooling is also observed.

TABLE 2
Summary for Thermal Effect on Grating of Example 3 and Example 4

| | | Example 3 | Example 4 |
|---|---|---|---|
| | | (Beam Writing | (Beam |
| | | Without | Writing |
| | | Preheat) | With preheat) |
| | Diffraction efficiency | 44% | 38% |
| Response | Response time to | 4000 s | 600 s |
| Time Speed | maximum (s) | | |
| | Response time to half | 2000 s | <200 s |
| | maximum (s) | | |
| Length of | Holding to half | >20 days | Several hours |
| Time | maximum (hrs) | | |
| Grating Held | Ratio of grating holding | 1000 | 40 |
| | time to response time | | |
| Temperature | Grating on | 20° C. | 35° C. |
| Control | Grating off | 60° C. | 20° C. |

Thus, thermal control processes (such as writing at different temperature, heating to a certain temperature for a short time, and reading at different temperature) can not only control whether a grating is turned on or off, but also the temperature at which the on/off switch is activated can also be controlled.

All literature references and patents mentioned herein are hereby incorporated in their entireties. Although the foregoing description has shown, described, and pointed out the fundamental novel features of the present teachings, it will be understood that various omissions, substitutions, and changes in the form of the detail of the apparatus as illustrated, as well as the uses thereof, can be made by those skilled in the art, without departing from the scope of the present teachings. Consequently, the scope of the present teachings should not be limited to the foregoing discussion, but should be defined by the appended claims.

1. An optical device comprising:
at least two inert layers; and
a photorefractive layer comprising a photorefractive composition, wherein the photorefractive layer is sandwiched between the two inert layers;
wherein the photorefractive composition is photorefractive upon irradiation by a laser beam;
wherein the photorefractive composition comprises a sensitizer and a polymer;
wherein the polymer comprises a first repeating unit that includes at least one moiety selected from the group consisting of the following formulae (Ia), (Ib) and (Ic): 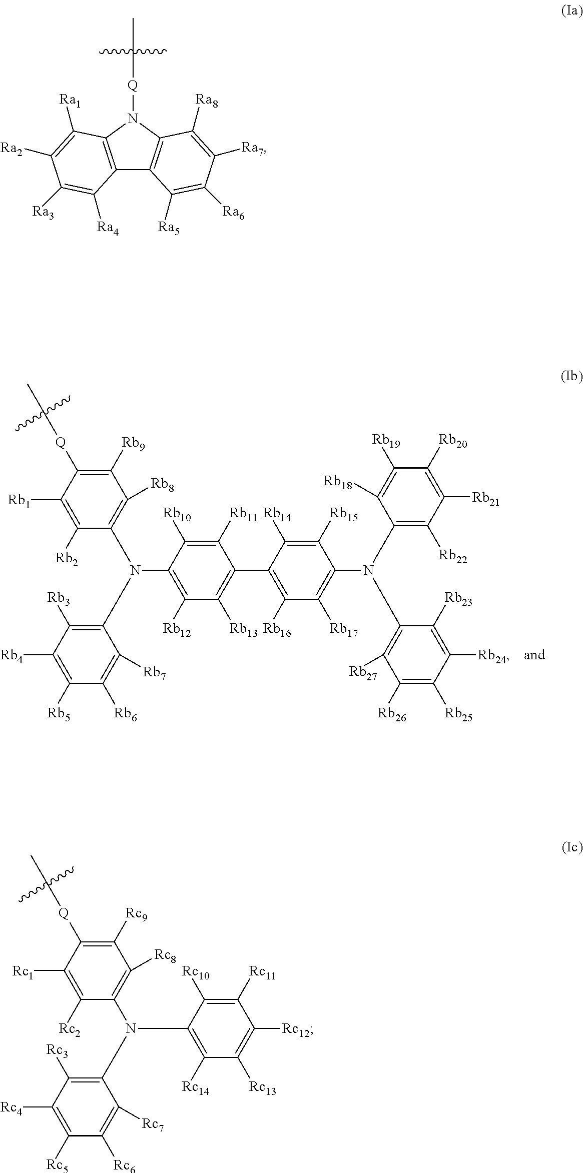
wherein each Q in formulae (Ia), (Ib) and (Ic) independently represents an alkylene or a heteroalkylene; Ra₁-Ra₈, Rb₁-Rb₂₇, and Rc₁-Rc₁₄ in formulae (Ia), (Ib), and (Ic) are each independently selected from the group consisting of hydrogen, linear or branched optionally substituted C₁-C₁₀ alkyl or heteroalkyl, and optionally substituted C₆-C₁₀ aryl;
wherein the photorefractive composition is formulated such that a grating that is irradiated into the photorefractive composition can be read out of the photorefractive composition without applying an external bias voltage; and
wherein the composition grating behavior can be controlled by thermal treatment.

2. The optical device of claim 1, wherein each of the inert layers independently comprises at least one polymer selected from the group consisting of poly(methyl methacrylate), polyvinyl alcohol, crosslinkable polyimide, non-crosslinkable polyimide, polycarbonate, amorphous polycarbonate, and polyvinylpyrrolidone

3. The optical device of claim 1, wherein the inert layers directly contact the photorefractive material.

4. The optical device of claim 1, wherein at least one inert layer comprises amorphous polycarbonate.

5. The optical device of claim 1, wherein the sensitizer comprises a molecule having a structure according to formulae (V), (VI), or (VII): 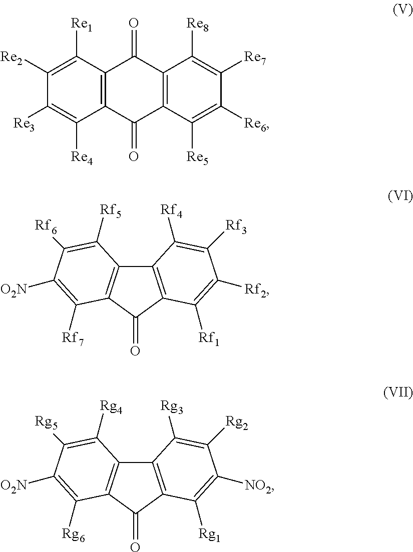
wherein Re₁-Re₈, Rf₁-Rf₇, Rg₁-Rg₆ are each independently selected from the group consisting of hydrogen, linear or branched C₁-C₁₀ alkyl or heteroalkyl, C₆-C₁₀ aryl, and a halogen.

6. The optical device of claim 1, further comprising two layers of indium tin oxide (ITO) coated glass plates, wherein the photorefractive layer and the two inert layers are sandwiched between the glass plates.

7. The optical device of claim 1, wherein the polymer further comprises a second repeating unit which includes a moiety represented by the following formula (IIa): 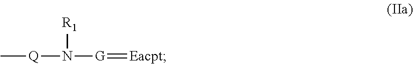
wherein Q in formula (IIa) represents an alkylene group or a heteroalkylene group; R₁ in formula (IIa) is selected from the group consisting of hydrogen, linear C₁-C₁₀ alkyl, branched C₁-C₁₀ alkyl, and C₆-C₁₀ aryl; G in formula (IIa) is a π-conjugated group; and Eacpt in formula (IIa) is an electron acceptor group.

8. The optical device of claim 7, wherein the second repeating unit is represented by the following formula (IIa′): 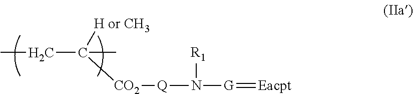
wherein Q in formula (IIa′) represents an alkylene group or a heteroalkylene group; R₁ in formula (IIa′) is selected from the group consisting of hydrogen, linear C₁-C₁₀ alkyl, branched C₁-C₁₀ alkyl, and C₆-C₁₀ aryl; G in formula (IIa′) is a π-conjugated group; and Eacpt in formula (IIa′) is an electron acceptor group.

9. The optical device of claim 7, wherein G in formulae (IIa) and (IIa′) is represented by a structure selected from the group consisting of the following formulae (G-1) and (G-2): 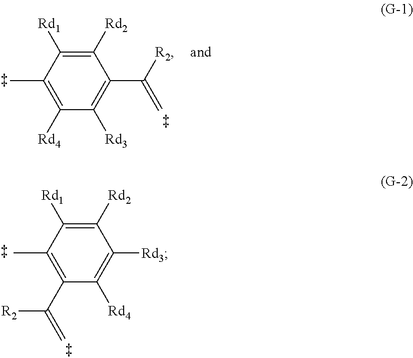
wherein Rd₁-Rd₄ in formulae (G-1) and (G-2) are each independently selected from the group consisting of hydrogen, linear C₁-C₁₀ alkyl, branched C₁-C₁₀ alkyl, C₆-C₁₀ aryl, and halogen; and each R₂ in formulae (G-1) and (G-2) is independently selected from the group consisting of hydrogen, linear C₁-C₁₀ alkyl, branched C₁-C₁₀ alkyl, and C₆-C₁₀ aryl.

10. The optical device of claim 7, wherein Eacpt in formulae (IIa) and (IIa′) is oxygen or is represented by a structure selected from the group consisting of the following formulae (E-2) to (E-6): 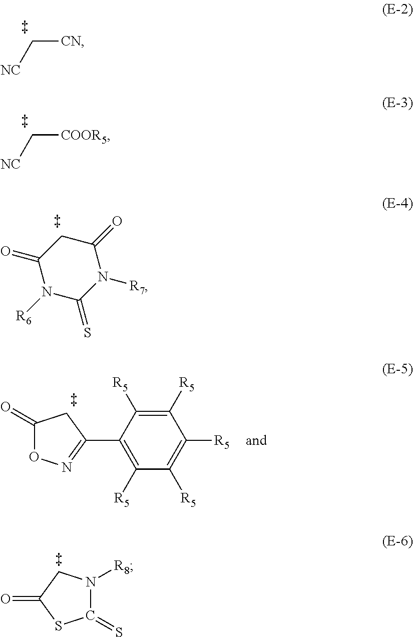
wherein R₅, R₆, R₇ and R₈ in formulae (E-3), (E-4), (E-5), and (E-6) are each independently selected from the group consisting of hydrogen, linear C₁-C₁₀ alkyl, branched C₁-C₁₀ alkyl, and C₆-C₁₀ aryl.

11. The optical device of claim 1, wherein the composition further comprises a chromophore.

12. The optical device of claim 1, wherein the composition further comprises a plasticizer.

13. The optical device of claim 1, wherein the polymer comprises a first repeating unit selected from the group consisting of the following formulae (Ia′), (Ib′) and (Ic′): 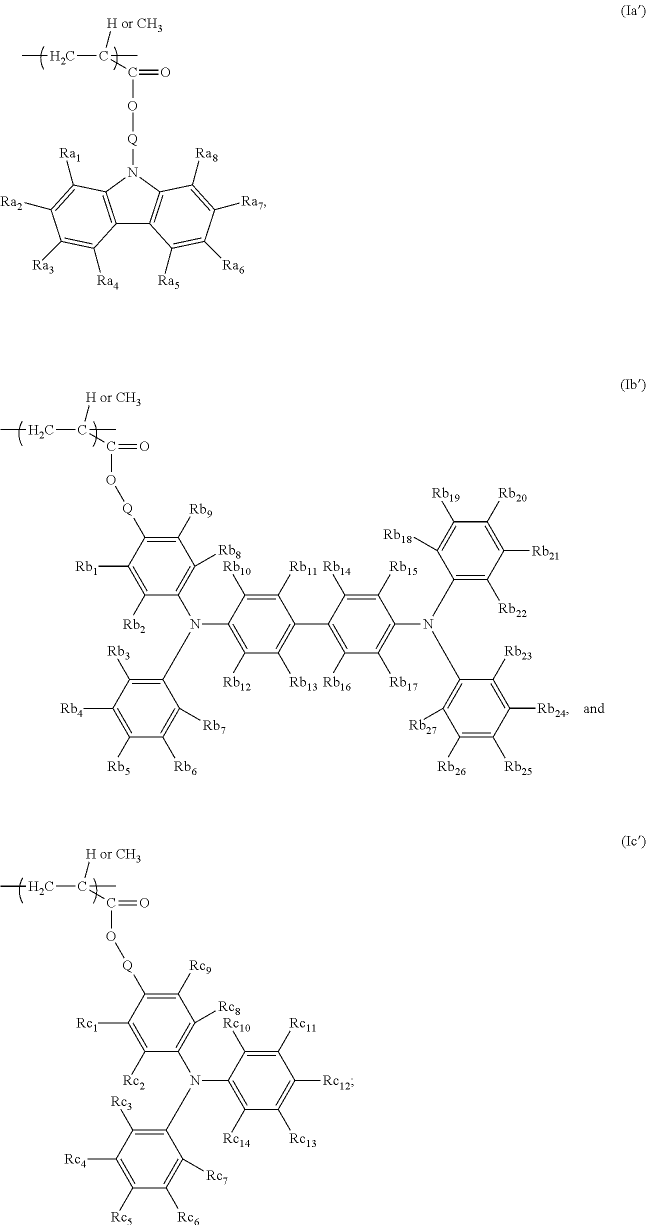
wherein each Q in formulae (Ia′), (Ib′) and (Ic′) independently represents an alkylene group or a heteroalkylene group; Ra₁-Ra₈, Rb₁-Rb₂₇ and Rc₁-Rc₁₄ in formulae (Ia′), (Ib′) and (Ic′) are each independently selected from the group consisting of hydrogen, linear or branched optionally substituted C₁-C₁₀ alkyl or heteroalkyl, and optionally substituted C₆-C₁₀ aryl.

14. The optical device of claim 1, wherein the composition has a transmittance of higher than about 30% at a thickness of 105 μm when irradiated by a laser beam.

15. The optical device of claim 1, wherein the composition is photorefractive upon irradiation by a laser beam having a wavelength in the range of from about 500 nm to about 700 nm.

16. A method of forming a grating in a photorefractive composition, comprising:
providing the optical device of claim 1; and
irradiating the photorefractive composition with a laser beam without an external bias voltage to form the grating.

17. The method of claim 16, wherein the laser beam has a wavelength in the range of from about 500 nm to about 700 nm.

18. The method of claim 16, further comprising reading a grating signal without applying an external bias voltage.

19. A method for modulating a grating signal of an optical device, comprising:
providing the optical device of claim 1, to which a grating has been written therein by irradiating the photorefractive composition with a laser beam at a first temperature; and
increasing the temperature of the optical device to a second temperature, wherein the intensity of the grating signal at the first temperature is higher than the intensity of the grating signal at the second temperature.

20. The method of claim 19, further comprising heat treating the optical device after the grating has been written.

21. The method of claim 19, wherein the grating signal is measured at the first and second temperatures without applying an external bias voltage.

22. The method of claim 19, wherein the first temperature is about room temperature, and wherein the second temperature is in the range of about 40° C. to about 80° C.

23. The method of claim 19, wherein the first temperature is in the range of about 18° C. to about 22° C., and wherein the second temperature is in the range of about 55° C. to about 65° C.

24. The method of claim 19, wherein the intensity of the grating signal at the first temperature is at least about 70% higher compared to the intensity of the grating signal at the second temperature.

25. The method of claim 19, wherein the grating signal is on at the first temperature and the grating signal is off at the second temperature.

26. The method of claim 19, further comprising:
decreasing the temperature of the optical device, such that the intensity of the grating signal is substantially restored.

27. The method of claim 26, wherein the grating signal is on after decreasing the temperature of the optical device.

28. A method for modulating a grating signal of an optical device, comprising:
providing the optical device of claim 1, to which a grating has been written therein by irradiating the photorefractive composition with a laser beam at a first temperature; and
cooling the optical device to a second temperature, wherein the intensity of the grating signal at the first temperature is higher than the intensity of the grating signal at the second temperature.

29. The method of claim 28, wherein the grating signals are measured at the first and second temperatures without applying an external bias voltage.

30. The method of claim 28, wherein the first temperature is in the range of about 30° C. to about 45° C., and wherein the second temperature is about room temperature.

31. The method of claim 28, wherein the first temperature is in the range of about 33° C. to about 37° C., and wherein the second temperature is in the range of about 18° C. to about 22° C.

32. The method of claim 28, wherein the intensity of the grating signal measurement at the first temperature is at least about 70% higher compared to the intensity of the grating signal measurement at the second temperature.

33. The method of claim 28, wherein the grating signal is on at the first temperature and is off at the second temperature.

34. The method of claim 28, further comprising:
increasing the temperature of the optical device, such that the intensity of the grating signal is substantially restored.

35. The method of claim 34, wherein the grating signal is on after increasing the temperature of the optical device.
